(19) United States
(12) Patent Application Publication
(10) Pub. No.: US 2025/0231742 A1
(43) Pub. Date: Jul. 17, 2025

(54) TRANSPOSING INFORMATION USING SHADOW LATCHES AND ACTIVE LATCHES FOR EFFICIENT DIE AREA IN PROCESSING SYSTEM

(71) Applicant: Tesla, Inc., Austin, TX (US)

(72) Inventors: Peter Sassone, Austin, TX (US); Peter Joseph Bannon, Austin, TX (US)

(21) Appl. No.: 18/854,766

(22) PCT Filed: Apr. 10, 2023
(86) PCT No.: PCT/US2023/018060

§ 371 Date: Oct. 7, 2024

Related U.S. Application Data
(60) Provisional application No. 63/362,876, filed on Apr. 12, 2022.

(51) Int. Cl. G06F 7/78

(52) U.S. Cl. CPC G06F 7/78

(57) ABSTRACT

Systems and methods for transposing information using shadow latches and active latches for efficient die area in processing system. An example storage includes groups of active latches and shadow latches, with the active/shadow storage receiving a first matrix comprising values, and with the active latches being enabled, over first clock cycles, such that the values are stored in the active latches. The shadow latches replicate the values stored in the active latches. The values replicated in the shadow latches are read over second clock cycles, with at least one value included in a second matrix being stored in at least one active latch over second clock cycles.

### CROSS-REFERENCE TO RELATED APPLICATIONS

This application claims priority to U.S. Prov. App. No. 63/362,876 titled “TRANSPOSING INFORMATION USING SHADOW LATCHES AND ACTIVE LATCHES FOR EFFICIENT DIE AREA IN PROCESSING SYSTEM” and filed on Apr. 12, 2022, the disclosure of which is hereby incorporated herein by reference in its entirety.

### BACKGROUND

### Technical Field

The present disclosure relates to transposing information using hardware elements, and more particularly, to transposing information using latches.

### Description of Related Art

Neural networks are relied upon for disparate uses and are increasingly forming the underpinnings of technology. For example, a neural network may be leveraged to perform object classification on an image obtained via a user device (e.g., a smart phone). In this example, the neural network may represent a convolutional neural network which applies convolutional layers, pooling layers, and one or more fully-connected layers to classify objects depicted in the image. As another example, a neural network may be leveraged for translation of text between languages. For this example, the neural network may represent a recurrent-neural network.

Typically, information may need to be transposed as part of training neural networks or at inference time. For example, a first matrix may be used to store information such as input data, weight data, and so on. In this example, the first matrix may be multiplied by a second matrix or by a vector (e.g., a column vector). As may be appreciated, multiplying the first matrix by the second matrix, or the first matrix by the column vector, requires that the number of columns in the first matrix be equal to the number of rows in the second matrix or column vector. Thus, for certain multiplications the first matrix may need to be transposed to switch the row and column indices of the matrix.

At present, hardware techniques to transpose matrices, for example in a streaming context, requires a large array of hardware elements which consume substantial die area.

### BRIEF DESCRIPTION OF THE DRAWINGS

FIG. 1A is a block diagram illustrating a matrix processor system which includes an example active/shadow storage for transposing data and an example matrix processor for processing data.

FIG. 1B is a block diagram illustrating details of the example active/shadow storage included in the matrix processor system.

FIG. 1C is a block diagram illustrating details of inputting data into the active/shadow storage.

FIG. 1D is a block diagram illustrating details of reading out transposed data from the active/shadow storage.

FIG. 2A is a block diagram illustrating an example of writing data to an active latch included in an example active/shadow storage.

FIG. 2B is a block diagram illustrating an example of storing data in a shadow latch included in the example active/shadow storage.

FIG. 2C is a block diagram illustrating an example of writing new data into the active latch and reading data from the shadow latch.

FIG. 3 is a flowchart of an example process for transposing data using active/shadow storage.

FIG. 4 is a block diagram illustrating an example vehicle which includes the matrix processor system.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

This application describes techniques to enable transposing data in a streaming context while efficiently utilizing die area. As will be described, information may be streamed during operation of a processor with the information being rapidly transposed when needed. The processor may be, for example, a matrix processor which is used to perform neural network processing. It may be appreciated that a matrix, such as a portion of an input image, feature maps, a filter or kernel, may be required to be transposed to allow for multiplying the matrix by another matrix or vector. Thus, transposing information may be a required step during processing of layers, such as convolutional layers, in a neural network. As will be described, the techniques described herein leverage an array or combination of active and shadow latches (referred to herein as active/shadow storage) to efficiently transpose information while limiting an extent to which die area devoted to transposing is required.

To transpose data, such as a matrix, using hardware elements, an example technique may use an array or combination of flip-flops (e.g., a 2D set of flip-flops). Each flip-flop may be used to store a bit included in the matrix. Thus, if the matrix is a 4×3 matrix which includes 12 values, there may be 12 flip-flops used to store the values. As may be appreciated, the 12 values may require more than one bit and there may therefore be more than 12 flip-flops used to store the values. To transpose the 4×3 matrix, the output of the flip-flops may be ordered such that the values are rotated about the diagonal of the matrix. In this way, the 4×3 matrix may be output (e.g., read out) as a 3×4 matrix.

While using a single flip-flop for each bit included in a matrix may allow for transposing data, it will not allow for doing so in a streaming context. For example, full pipelining cannot be used assuming the matrix cannot be read or written in a particular number of clock cycles (e.g., a single clock cycle, a clock cycle per row of a matrix, and so on). As known by those skilled in the art, the inability to function in a streaming context will preclude use of this technique as new inputs cannot be written until all outputs have been read. Thus, the throughput and overall processing speed will be limited.

Another example technique to transpose data may include using two flip-flops for each bit. This may allow for transposing data in a streaming context, for example allowing new information to be written while old information is being read. As an example, the two-flip-flops for each bit may include a first flip-flop and a second flip-flop. The second flip-flops may receive copies of information from first flip-flops after the information is written to the flip-flops. The information may then be read from the second flip-flops while new information is being written to the first flip-flops. However, this example technique may substantially increase the required die area assigned to transposing data. The increased complexity and cost, along with potentially reducing space for other hardware elements in a processor, may cause use of two-flip-flops for each bit to be disfavored.

The techniques described herein advantageously allow for two latches to be used for each bit of a matrix which is to be transposed. A latch, for example an SR latch, may require substantially less die area than a flip-flop which, as an example, may be formed from two latches. Additionally, the regular structure may lend itself to scripted physical placement such that manufacturing of active/shadow storage may be enhanced.

As will be described, the two latches may include an active latch and a shadow latch. For example, values included in a matrix may be written to the active latches over one or more clock cycles. In this example, the values may then be stored in the shadow latches. New values included in a new matrix may then be written to the active latches while the values are read from the shadow latches. In this way, the techniques described herein allow for streaming of information to be transposed during operation of a processor.

To control operation of the active and shadow latches, different clock gates may be used. For example, the active latches may be controlled via a first clock gate signal while the shadow latches may be controlled via a second clock gate signal. In this example, the active and shadow latches may therefore be enabled at specific times to ensure proper operation of the active/shadow storage.

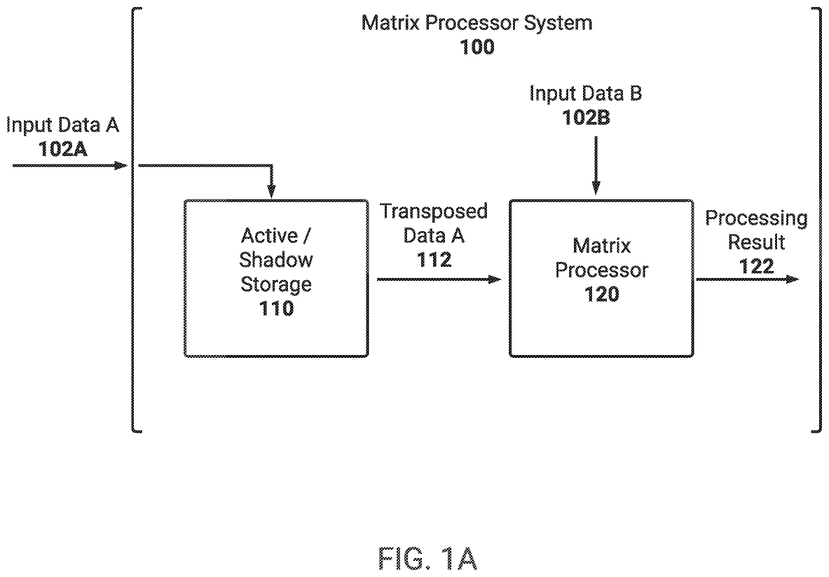

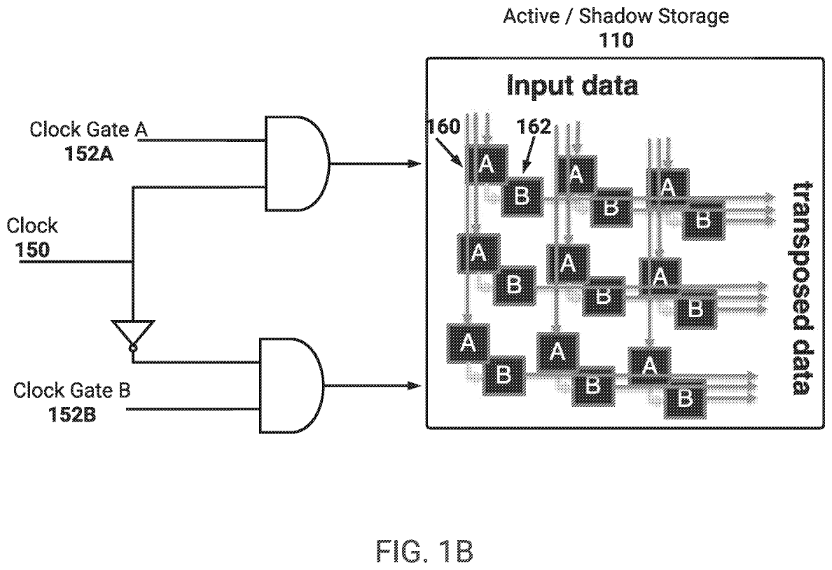

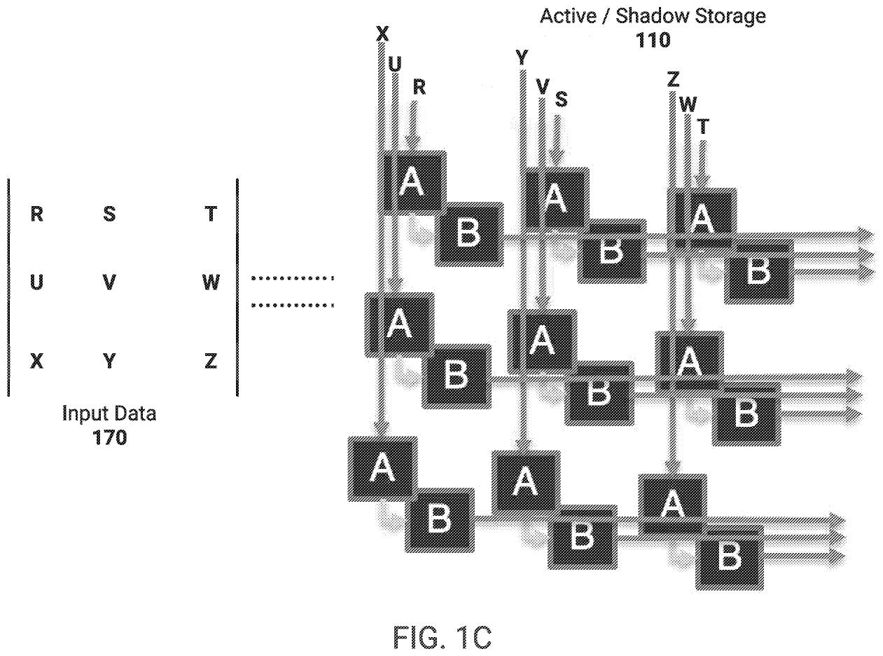

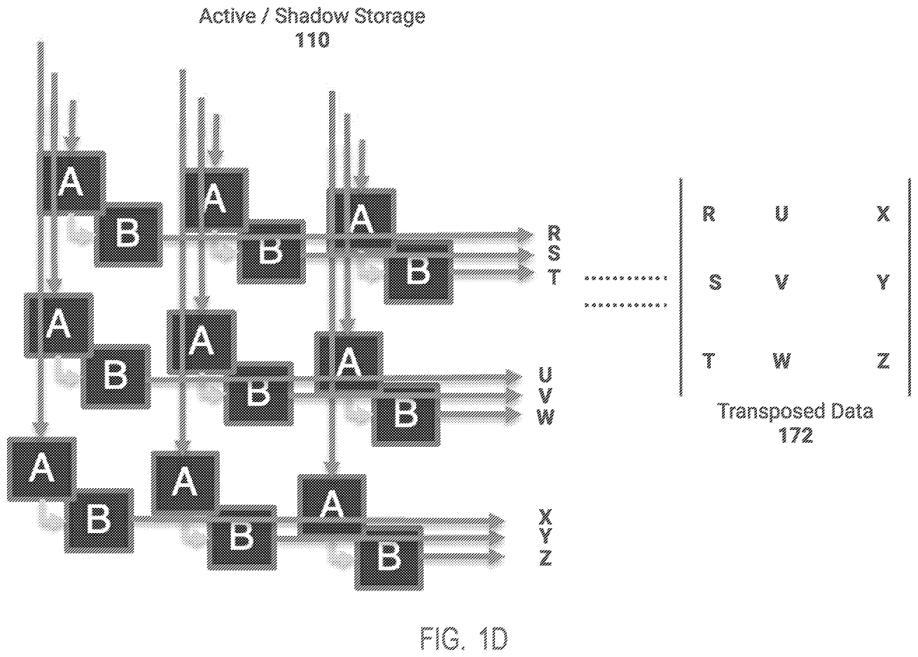

In some embodiments, the active latch may be transparent on the high phase of a clock when input data is ready. The shadow latch may be transparent on the low phase of the clock when data is ready to be moved from the active latch to the shadow latch. Thus, in some embodiments the same clock may be used (e.g., as described at least in FIG. 1B).

In some embodiments, the innovation may be used for algorithms other than a pure transpose. For example, a circuit may read the diagonal elements of an array out one at a time. Without the techniques described herein, this could not be done naively without either stalling the line writes until the diagonal reads were done.

### Block Diagrams

FIG. 1A is a block diagram illustrating a matrix processor system 100 which includes an example active/shadow storage 110 for transposing data and an example matrix processor 120 for processing data. The matrix processor system 100 may be used, for example, to compute forward passes through layers of a neural network. In some embodiments, the neural network may represent a convolutional neural network in which image or video information is processed.

In the illustrated example, input data 102A is being provided to the matrix processor system 100. The input data 102A, as described above, may represent an input image, one or more feature maps, or a portion thereof. For example, the portion may represent a particular window of the input data which is to be multiplied by weight data (e.g., one or more kernels or filters). The input data 102A may also represent information being input into a layer of a neural network, such as a convolutional, transformer, or fully-connected network, which is to be multiplied with weight information (e.g., a weight matrix).

As known by those skilled in the art, the input data 102A may need to be transposed to multiply the input data 102A with other input data 102B. For example, the input data 102A may represent a 20×10 matrix which includes 120 values. In this example, the input data 102B may represent a 20×4 matrix which includes 80 values. Thus, to multiply these matrices the input data 102A is transposed into a 10×20 matrix.

The matrix processor system 100 includes an active/shadow storage 110 to transpose the input data 102A into transposed data 112. As described above, and as will be described in more detail, the active/shadow storage 110 includes a multitude of active and shadow latches. Each active latch may be connected to an individual shadow latch in the storage 110. In some embodiments, the active/shadow storage 110 may include an array of active and shadow latches. For example, there may be an array of groups of active and shadow latches organized into rows and columns. In this example, there may be 32×32, 20×20, 36×48, and so on groups of active and shadow latches.

The input data 102A may be written to the active latches over one or more clock cycles. For example, at each clock cycle a particular amount of data (e.g., obtained from outside memory) may be written to the active/shadow storage 110. In some embodiments, the amount of data may be 8 bits, 10 bits, 16 bits, 32 bits, and so on. In some embodiments, and as will be described below with respect to FIG. 1B, the number of clock cycles may correspond to a number of rows included in the input data 102A.

In this way, the matrix processor 120 may determine a processing result 122 associated with the multiplication of input data 102A and input data 102B. The processing result 122 may represent, for example, an output associated with multiplying input data and weights in a layer of a neural network. The processing result 122 may also represent, for example, an output associated with a portion of processing performed in a layer of a neural network. In some embodiments, the processing result 122 may represent one or more windows of input information (e.g., input image, feature maps, and so on) convolved with one or more filters or kernels.

While FIG. 1A shows the input data 102A being transposed, for example via the active/shadow storage 110, in some embodiments input data B 102B may be transposed.

An example matrix processor 120 is described in more detail with respect to U.S. Pat. Nos. 11,157,287, 11,409,692, and 11,157,441, which are hereby incorporated by reference in their entirety and form part of this disclosure as if set forth herein.

FIG. 1B is a block diagram illustrating detail of the example active/shadow storage 110 included in the matrix processor system 120. The active/shadow storage 110 includes a multitude of latches which may characterized as either active latches (e.g., ‘A’ latches) or shadow latches (e.g., ‘B’ latches). In some embodiments, an individual active latch may be associated with an individual shadow latch to form a group of latches, such as active latch 160 and shadow latch 162. Each group of latches may be used for an individual bit of input data (e.g., a matrix of values), such that each bit of input data is associated with two latches included in the active/shadow storage 110.

The active latches, such as active latch 160, may receive respective bits of input data. For example, the input data may include a matrix of values which is to be transposed. In this example, each value of the matrix (e.g., a particular row and column element of the matrix) may be represented by one or more bits. Thus, each active latch may receive one of the bits for storage.

In some embodiments, active latch 160 may represent a group of active latches. For example, each active latch in the group of active latches may be used to a store one bit associated with a larger value (e.g., a byte, a word, an integer, a float, and so on). Similarly, shadow latch 162 may represent a group of shadow latches which receives information from the group of active latches. In this way, the active/shadow storage 110 may be used to transpose a matrix of values which are bytes, words, integers, and so on.

As may be appreciated, the values included in a matrix of values may be provided to the active/shadow storage 110 over one or more cycles. For example, the values may be obtained from an element (e.g., memory, which is not illustrated in FIG. 1B) and provided over a bus to the active/shadow storage 110. This bus may have a width or bandwidth which causes the values to be provided over more than one clock cycle. In some embodiments, the number of clock cycles may be based on a size of the matrix. For example, the number of clock cycles may correspond to a number of rows included in the matrix. In this example, the active latches which are included in, or otherwise assigned to or associated with, a same column of the active/shadow storage 110 may receive respective bits in a same clock cycle (e.g., since the data is being transposed, the active latches in the same column may be associated with a row included in the matrix). As another example, the number of clock cycles may correspond to a number of columns included in the matrix. In this example, the active latches which are included in, or otherwise assigned to or associated with, a same row of the active/shadow storage 110 may receive respective bits in a same clock cycle.

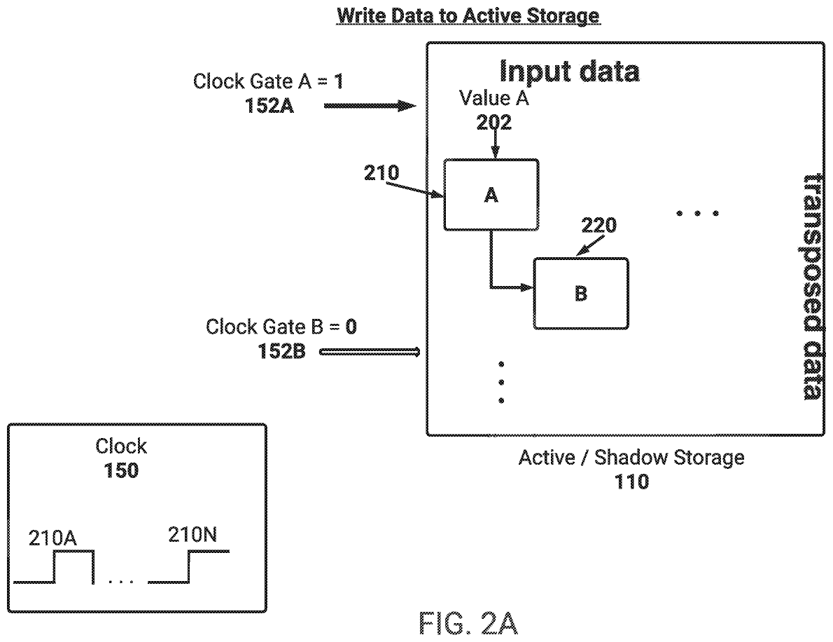

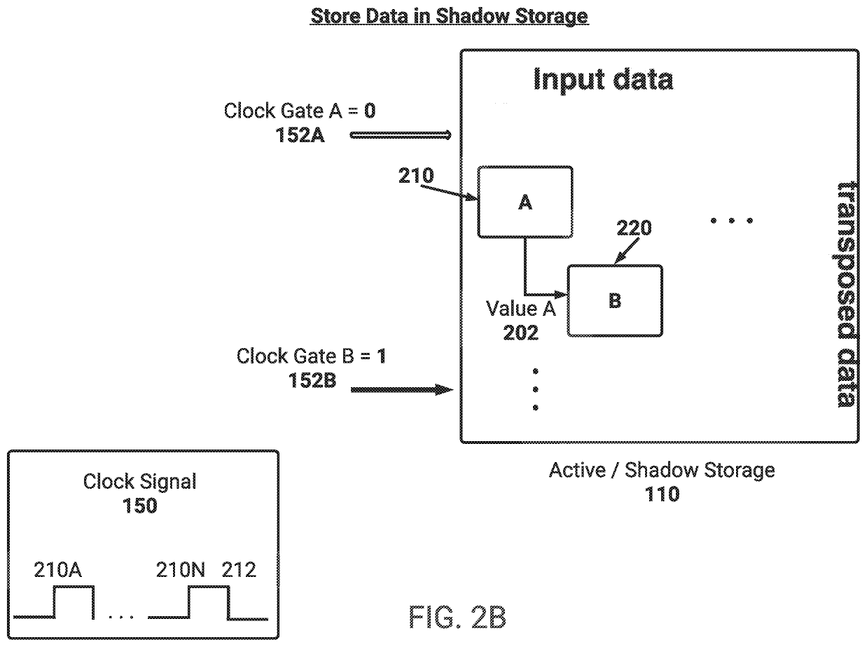

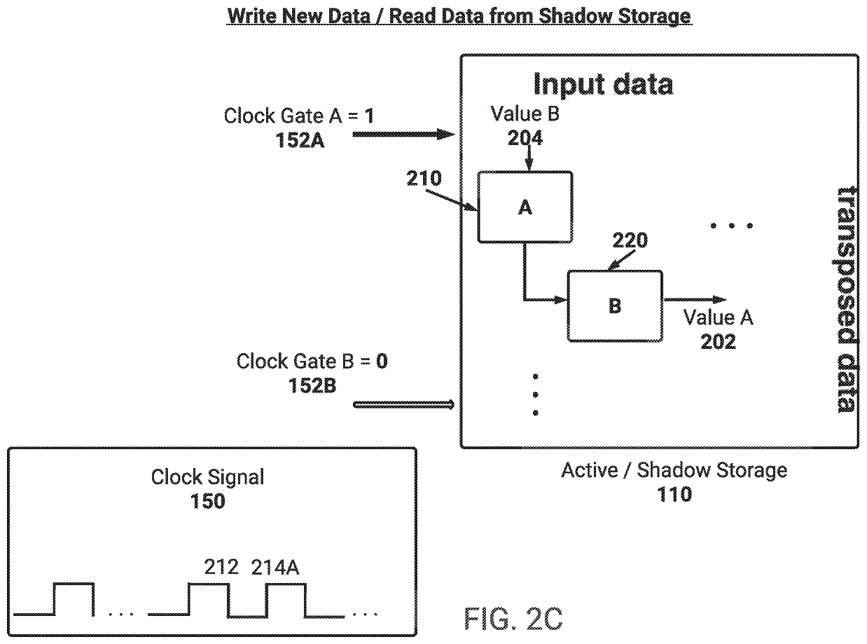

Once the bits included in the matrix of values are stored in the active latches, the shadow latches may store copies of the bits. For example, shadow latch 162 may receive the bit stored in active latch 160. As will be described in FIGS. 2A-2C, the shadow latches may replicate the information in the active latches upon a particular clock edge (e.g., rising clock edge, descending clock edge). For example, the shadow latches 162 may be enabled at a substantially same time to store the bits included in the matrix of values.

Subsequently, the information stored in the shadow latches may be read over one or more clock cycles. For example, each row of shadow latches included in the active/shadow storage 110 may be addressed and the bits stored therein read from the shadow latches. As another example, each column of shadow latches included in the active/shadow storage 110 may be addressed and the bits stored therein read from the shadow latches. As illustrated, the matrix of values may be read such that the matrix is transposed. For example, the values may be flipped over the diagonal of the matrix.

The number of clock cycles to read the information may optionally be based on a number of columns included in the matrix of values. For example, if the matrix of values is an M×N matrix where each value is a bit then there may be M clock cycles to write N bits of information into the active latches. In this example, there may be N clock cycles to read M bits of information from the shadow latches.

As may be appreciated, while the information stored in the shadow latches is being read, new information (e.g., a new matrix of values) may be stored in the active latches over one or more clock cycles. During operation of the active/shadow storage 110, for example during steady-state operation, the active latches may be written to while the shadow latches are read from. Advantageously, the active latches and shadow latches may store different data such that during steady-state operation matrices may be streamed to the storage 110 and then transposed in a streaming context.

In some embodiments, the active/shadow storage 110 may write information to the active latches at each clock cycle while also reading information from the shadow latches at the clock cycle. For example, square matrices may cause a same number of writes to be performed as a number of reads. With respect to the example above of an M×N matrix, if M is the same as N then there may be M clock cycles to write M bits of information into the active latches and M clock cycles to read M bits of information from the shadow latches. However, in some embodiments non-square matrices may cause a different number of writes to be performed as a number of reads. With respect to an M×N matrix, where M is 10 and N is 16, there may be 10 cycles of 16 bit writes into the active latches and 16 cycles of 10 bit reads from the shadow latches. Thus, pipelining (e.g., streaming) of matrices may be adjusted depending on the dimensions of a matrix. For example, the storage 110 may limit an extent to which new information is written to the active latches (e.g., the storage 110 may write 10 out of every 16 clock cycles with respect to the example above).

To allow for use of latches, and thus to reduce a die area as compared to use of another technique for transposing matrices (e.g., flip-flops), a clock 150 may be separately gated for the active latches and shadow latches. For example, clock gate 152A may be toggled on or off to enable or disable the active latches. As another example, clock gate 152B may be toggled on or off to enable or disable the shadow latches. In the illustrated embodiment, a same clock is used such that the active latches and shadow latches use opposite edges of the clock (e.g., high phase, low phase).

In this way, the active latches and shadow latches may be separately controlled. In some embodiments, the clock gates 152A and 152B may be toggled according to instructions being executed by the matrix processor system 100. The active latches and shadow latches may, in some embodiments, set to be active on opposite edges of the clock 150. For example, the active latches may be enabled based on rising edges of the clock 150 while the shadow latches may be enabled based on falling edges of the clock 150 (e.g., or vice-versa). FIGS. 2A-2C describe additional detail associated with toggling the active latches and shadow latches on or off.

FIG. 1C is a block diagram illustrating detail of inputting data into the active/shadow storage 110. Example input data 170 is included in FIG. 1C, with the input data 170 representing a 3×3 matrix. As may be appreciated, the dimensions of the matrix, and latches included in the storage 110, are arbitrary, and the techniques described herein may be applied to different data structures. The input data 170 includes values R through Z, with each value representing a bit, a byte, a word, and so on as described above.

An example implementation of inputting the input data 170 into the storage 110 is illustrated. In the example, the first row of values is input into the upper row of active latches. The second row of values is input into the middle row of active latches. The third row of values is input into the bottom row of active latches.

FIG. 1D is a block diagram illustrating detail of reading out transposed data 172 from the active/shadow storage 110. As illustrated, information may be read out from the storage 110 such that the input data 170 is transposed into transposed data 172. As described above, information may be input into the storage 110 over one or more cycles. For example, the above-described first row of values may be input during one clock step, and the second row may be input during a next clock step. The values input into the storage 110, and thus stored in the active latches as described herein, may then be stored by the shadow latches.

In the illustrated example, the top row of the transposed data 172 is read from left-most shadow latches. The middle row of the transposed data 172 is read from the middle shadow latches. The bottom of the transposed data 172 is read from the right-most shadow latches. As may be appreciated, and as described herein, while data is being read from the shadow latches new data (e.g., new input data to be transposed) may be stored in the active latches. In this way, data may be transposed in a streaming fashion.

FIG. 2A is a block diagram illustrating an example of writing data to an active latch 210 included in the example active/shadow storage 110. The active latch 210 (e.g., the ‘A’ latch) may represent an individual active latch included in the storage 110, such as active latch 160. In the illustrated example, value A 202 is being written to the active latch 210. As described herein, value A 202 may be a bit included in a matrix of values. For example, the matrix may be an M×N matrix of bits (e.g., M*N bits). In this example, there may be, at least, M×N active latches and M×N shadow latches (e.g., 2*M*N latches). As another example, the matrix may be separated into two or more matrices depending on a number of latches included in the active/shadow storage 110.

To store value A 202 in active latch 210, clock gate 152A may be enabled. As illustrated, clock gate 152A is set to be enabled such that the active latch 210 can store value A 202. To write a matrix of values to the active latches 110, one or more clock cycles may be required. In FIG. 2A, a multitude of clock cycles of clock 150 are illustrated in which rising edges 210A-210N cause the active latches to be enabled. For example, the clock gate 152A may be set to enable (e.g., logical ‘1’) and the active latches enabled based on the clock being positive (e.g., logical ‘1’).

In FIG. 2A, the shadow latches are disabled based on clock gate 152B being set to disable (e.g., logical ‘0’). As will be described below, shadow latch 220 may be enabled to replicate value A 202.

FIG. 2B is a block diagram illustrating an example of storing data in a shadow latch 220 included in the example active/shadow storage 110. Once the active latches are written to in the active/shadow storage 110, for example active latch 210, the shadow latches may be enabled to store copies of the information stored in the active latches.

In the illustrated example, clock gate 152B has been set to enable (e.g., logical ‘1’), such that on falling edge 212 of the clock 150 the shadow latch 220 is enabled. In addition to shadow latch 220, in some embodiments all shadow latches 220 may be enabled to replicate values in their corresponding active latches. Clock gate 152A is optionally set to be disabled, such that new information (e.g., a new matrix of values) is not written into the active latches.

FIG. 2C is a block diagram illustrating an example of writing new data into the active latch 210 and reading data from the shadow latch 220. As described in FIG. 2B, the shadow latch 220 stores value A 202 at the falling edge 212 of the clock 150. To ensure that the active/shadow storage 110 operates in a streaming context, such that during steady-state operation the information may be written/read during a same clock cycle, new information may be written to active latch 210 while old information is read from shadow latch 220.

In the illustrated example, clock gate 152A is set to enable while clock gate 152B is set to disable. Thus, new information (e.g., value B 204) may be written to active latch 210. For example, at rising edge 214A of the clock 150 the value B 204 may be stored in the active latch 210. With clock gate 152B set to disable, at the subsequent falling edge of the clock 150 the shadow latch 220 may retain value A 202. Advantageously, value A 202 may be read during the clock cycle such that new information (e.g., value B 204) is written while old information (e.g., value A 202) is read.

With respect to steady-state operation, as may be appreciated the values of the new information may be written to the active latches over one or more clock cycles. Similarly, during these clock cycles the old information may be read from the shadow latches.

### Example Flowchart

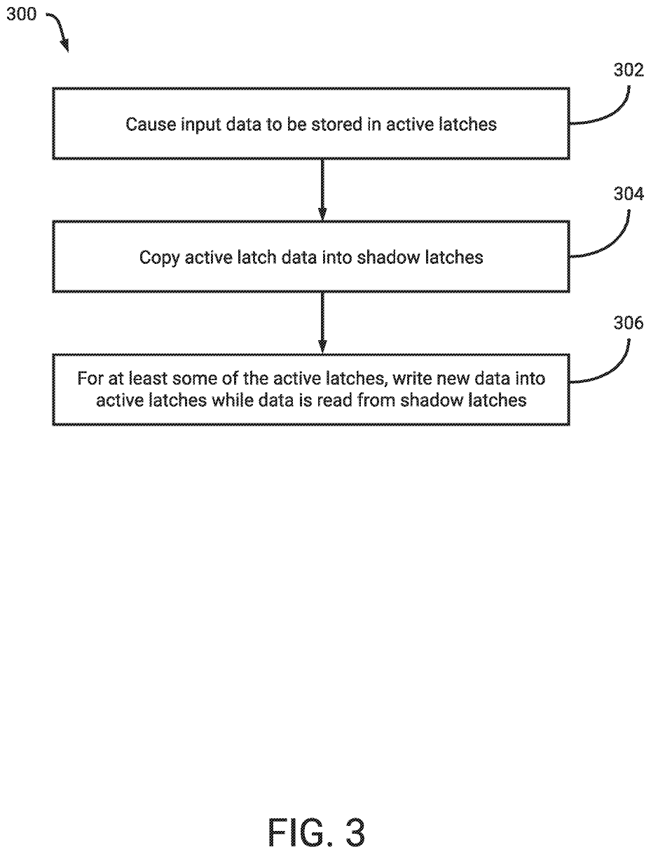

FIG. 3 is a flowchart of an example process 300 for transposing data using active/shadow storage. For convenience, the process 300 will be described as being performed by the matrix processor system 100.

At block 302, the system causes input data to be stored in active latches of the active/shadow storage. During operation of the system, input data may be obtained (e.g., based on instructions, such as software instructions) which is to be transposed. This information may be provided to the active/shadow storage which includes a multitude of groups of active latches and shadow latches. Each group of active latches and shadow latches may be associated with a bit of the input data. As described in FIG. 2A, over one or more clock cycles the input data may be stored in the active latches. For example, the active latches may be enabled via a first clock gate signal being set to be enabled.

At block 304, the system copies active latch data into the shadow latches. A second clock gate signal may be enabled, and optionally the first clock gate signal set to be disabled, which causes the shadow latches to be enabled. Once enabled, the shadow latches may store (e.g., replicate or copy) the information stored in the active latches.

At block 306, the system reads data from the shadow latches while new data is written to at least some of the active latches. As described in FIG. 2C, the information stored in the shadow latches may be read over one or more clock cycles. The information may be read such that the values obtained in block 302 may be transposed (e.g., flipped over the diagonal). While the information is being read, at least some of the active latches may be enabled over the one or more clock cycles such that new information is stored in the active latches.

### Vehicle Block Diagram

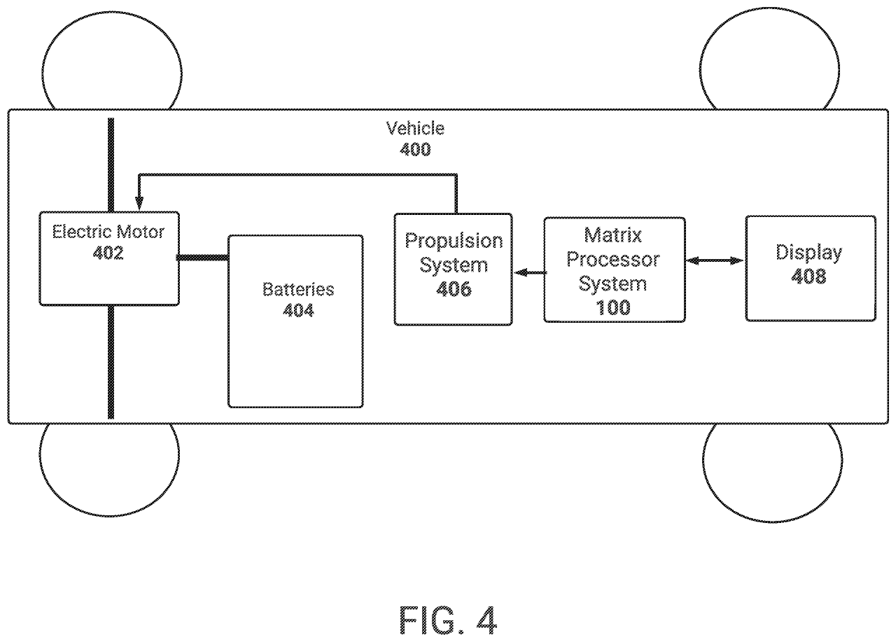

FIG. 4 illustrates a block diagram of a vehicle 400 (e.g., vehicle 102). The vehicle 400 may include one or more electric motors 402 which cause movement of the vehicle 400. The electric motors 402 may include, for example, induction motors, permanent magnet motors, and so on. Batteries 404 (e.g., one or more battery packs each comprising a multitude of batteries) may be used to power the electric motors 402 as is known by those skilled in the art.

The vehicle 400 further includes a propulsion system 406 usable to set a gear (e.g., a propulsion direction) for the vehicle. With respect to an electric vehicle, the propulsion system 406 may adjust operation of the electric motor 402 to change propulsion direction.

Additionally, the vehicle includes the matrix processor system 100 which is configured to transpose information as described herein. The matrix processor system 100 may process data, such as images received from image sensors positioned about the vehicle 400 (e.g., cameras 104A-104N). The matrix processor system 100 may additionally output information to, and receive information (e.g., user input) from, a display 408 included in the vehicle 400.

### Other Embodiments

All of the processes described herein may be embodied in, and fully automated, via software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence or can be added, merged, or left out altogether (for example, not all described acts or events are necessary for the practice of the algorithms). Moreover, in certain embodiments, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

The various illustrative logical blocks, modules, and engines described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is understood with the context as used in general to present that an item, term, etc., may be either X, Y, or Z, or any combination thereof (for example, X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure.

What is claimed is:

1. A matrix processor system comprising:
an active/shadow storage comprising groups of active latches and shadow latches, wherein the active/shadow storage is configured to:
receive a first matrix comprising a plurality of values,
enable, over one or more first clock cycles, the active latches, such that the values are stored in the active latches,
cause the shadow latches to replicate the values stored in the active latches, and
read, from the shadow latches over one or more second clock cycles, the values replicated in the shadow latches, wherein the values are transposed as compared to the first matrix, and wherein at least one value included in a second matrix is stored in at least one active latch over the one or more second clock cycles.

2. The system of claim 1, wherein the active latches are configured to be enabled at a first edge of a clock signal.

3. The system of claim 2, wherein the shadow latches are configured to be enabled at a second edge of the clock signal opposite to the first edge.

4. The system of claim 1, wherein the active latches are associated with a first clock gate and wherein the shadow latches are associated with a second clock gate.

5. The system of claim 4, wherein the first clock gate and the second clock gate are enabled on opposite edges of a clock signal.

6. The system of claim 4, wherein an instruction sets the first clock gate and the second clock gate.

7. The system of claim 1, wherein the values are respective bits.

8. The system of claim 1, wherein the active latches are enabled based on a particular clock gate being set to be enabled, and wherein the shadow latches are disabled.

9. The system of claim 1, wherein the shadow latches replicate the values based on a particular clock gate being set to be enabled, and wherein the active latches are disabled.

10. The system of claim 1, wherein the values are read based on a first clock gate being set to be disabled, wherein the particular clock gate is associated with the shadow latches, and wherein a second clock gate associated with the active latches being set to be enabled.

11. The system of claim 1, wherein individual groups include an individual active latch connected to an individual shadow latch.

12. The system of claim 1, wherein the first matrix is associated with input to a neural network layer.

13. The system of claim 1, wherein the transposed values are provided as input to a matrix processor.

14. A method implemented by a matrix processor system configured to transpose input data, wherein the method comprises:
cause the input data to be stored in active latches included in an active/shadow storage of the matrix processor system, wherein the active/shadow storage includes a plurality of groups of active latches and shadow latches, wherein individual groups include an individual active latch connected to an individual shadow latch;
copy information stored in the active latches to the shadow latches; and
for at least some of the active latches, store new input data into the active latches while the copied information is being read from the shadow latches, wherein the copied information being read from the shadow latches is transposed as compared to the input data.

15. The method of claim 14, wherein information stored in the active latches is copied based on a particular clock gate being set to be enabled, wherein the particular clock gate is associated with the shadow latches.

16. The method of claim 14, wherein the input data is stored in the active latches based on a particular clock gate being set to be enabled, wherein the particular clock gate is associated with the active latches.

17. The method of claim 16, wherein the new input data is stored in the active latches based on the particular clock gate being set to be enabled, wherein a different clock gate associated with the shadow latches is set to be disabled.

18. The method of claim 14, wherein the input data is associated with input to a neural network layer.

19. The method of claim 14, wherein the transposed copied information is provided as input to a matrix processor.

20. The method of claim 14, wherein the active latches are associated with a first clock gate and wherein the shadow latches are associated with a second clock gate.
